(19) United States
(12) Patent Application Publication
(10) Pub. No.: US 2005/0253813 A1
(43) Pub. Date: Nov. 17, 2005

(54) Enhanced visibility character identification system

(76) Inventor: Philip M. Sieg, Chattanooga, TN (US)

Correspondence Address: Philip M. Sieg;Suite 100, Crown Marketing Group, 1222 Tremont St., Chattanooga, TN, 37405, US

(21) Appl. No.: 11/116,731

(22) Filed: Apr. 28, 2005

Related U.S. Application Data
(60) Provisional application No. 60/570,920, filed on May 14, 2004.

(51) Int. Cl. G09G 5/00

(52) U.S. Cl. 345/168

(57) ABSTRACT

An enhanced visibility lettering system comprising means to enter information into an electronic device, larger characters identifying the letters, numbers, symbols and functions that the means to enter information control; wherein the means to enter information upon which the characters are placed are larger than the keys of a conventional keyboard, wherein the larger characters are centrally oriented on the means for entering information, and wherein the surface area used by the larger characters is greater than the surface area used by the characters on the keys of a keyboard that does not have the enhanced visibility lettering system is provided.

### CROSS-REFERENCES TO RELATED APPLICATIONS

This application claims the benefit of Provisional Application No. 60/570,920 filed May 14, 2004. The prior application is hereby incorporated herein by reference as though fully set forth herein.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

This invention relates generally to enhancing visibility of characters on means for entering data and more particularly to a system to enhance visibility of identifying marks on keys for keyboards and other devices that enter data into a computer or other device, and to keyboards.

2. Description of the Related Art

The closest prior art of which applicant is aware is U.S. Pat. No. 6,331,083 titled “Individual Key Covers for Computer Keyboards,” issued to Harris. Harris provides key covers for individual keys of a computer keyboard having a letter for each key that is larger than the letter on the computer key. Harris discloses only key covers for alphabetical characters.

Another patent, U.S. Pat. No. Des. 358,383, issued to Wagstrom, titled “Children's Computer Keyboard with Large Colorful Alphabetically Colored Keys” discloses an ornamental design for a children's keyboard.

To date, a simple but solution suitable to the unique needs of visually impaired users has yet to appear. One problem with existing keyboard and character identification systems is that the characters identifying the keys are not large enough to be easily recognized by visually impaired users. Another problem with existing keyboard and lettering systems is that the placement of characters on the keys interferes with recognition of those characters by visually impaired users. Existing keyboards may use specialized layouts that require the user to depart from the standard QWERTY layout, which can be quite burdensome to the user, especially so to a user who is visually impaired. Some keyboards for visually impaired users are significantly larger than conventional keyboards and take up so much space that the user's workspace efficiency is disadvantaged. Because such larger keyboards may not be aesthetically appealing to the visually impaired user, a visually impaired user may be reluctant to use a larger keyboard that draws attention to the user's impairment. Therefore, there is a resulting need in the art for an improved character identification system.

### BRIEF SUMMARY OF THE INVENTION

In accordance with one embodiment of the present invention, an enhanced visibility character identification system is provided that allows a visually impaired user to input data or other information to a computer via a keyboard whose characters are readily recognizable by the user because the characters for the keyboard's letters, numbers and symbols are larger, and some of the keys upon which characters are placed are larger themselves. The characters of the enhanced visibility character identification system are centrally oriented on the keys. The footprint size of a keyboard with the enhanced visibility character identification system is similar to the footprint size of a conventional computer keyboard that does not incorporate the enhanced visibility character identification system. These and other features of the invention are described in greater detail below.

### BRIEF DESCRIPTION OF THE SEVERAL VIEWS OF THE DRAWINGS

FIG. 1A is a top view of one embodiment of the present invention.

FIG. 1B is a top view of one embodiment of the present invention.

FIG. 2 is a top view of one embodiment of the present invention.

FIG. 3A is a top view of a keyboard that does not have the enhanced visibility character identification system.

FIG. 3B is a top view of a keyboard that does not have the enhanced visibility character identification system.

FIG. 4 is a top view of a keyboard that does not have the enhanced visibility character identification system.

FIG. 5 is a top view of one embodiment of the present invention alongside a keyboard that does not have the enhanced visibility character identification system.

FIG. 6 is a blowup of one embodiment of the present invention alongside a blowup of part of keyboard that does not have the enhanced visibility character identification system.

FIG. 7 is a blowup of one embodiment of the present invention alongside a blowup of part of keyboard that does not have the enhanced visibility character identification system.

FIG. 8 is a blowup of part of one embodiment of the present invention alongside a blowup of part of keyboard that does not have the enhanced visibility character identification system.

FIG. 9 is a blowup of part of one embodiment of the present invention alongside a blowup of part of keyboard that does not have the enhanced visibility character identification system.

FIG. 10 is a blowup of part of one embodiment of the present invention alongside a blowup of part of keyboard that does not have the enhanced visibility character identification system.

FIG. 11 is a blowup of part of one embodiment of the present invention alongside a blowup of part of keyboard that does not have the enhanced visibility character identification system.

FIG. 12 is a blowup of one embodiment of the present invention alongside a blowup of part of keyboard that does not have the enhanced visibility character identification system.

FIG. 13 is a blowup of one preferred embodiment of the present invention alongside a blowup of part of keyboard that does not have the enhanced visibility character identification system.

FIG. 14 is a top view of a first preferred embodiment of the present invention.

FIG. 15A is a top view of a first preferred embodiment of the present invention.

FIG. 15B is a top view of a first preferred embodiment of the present invention.

### DETAILED DESCRIPTION OF THE INVENTION

One embodiment of such a device is an enhanced visibility character identification system comprising a standard QWERTY layout keyboard having unique characters on its keys to identify the letters, numbers, symbols, or functions that those keys control.

The following examples have been selected to further illustrate features, advantages, and other details of the invention. It is to be expressly understood, however, that while the examples serve this purpose, the particular materials and construction as well as other details are not to be construed in a manner that would unduly limit the scope of this invention.

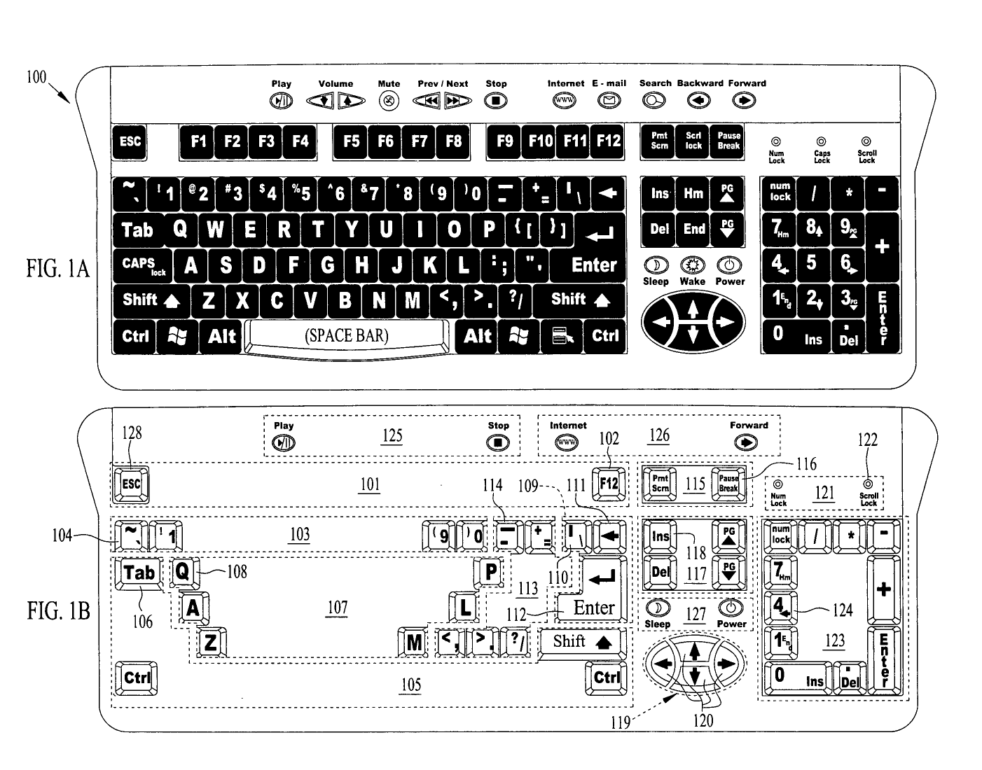

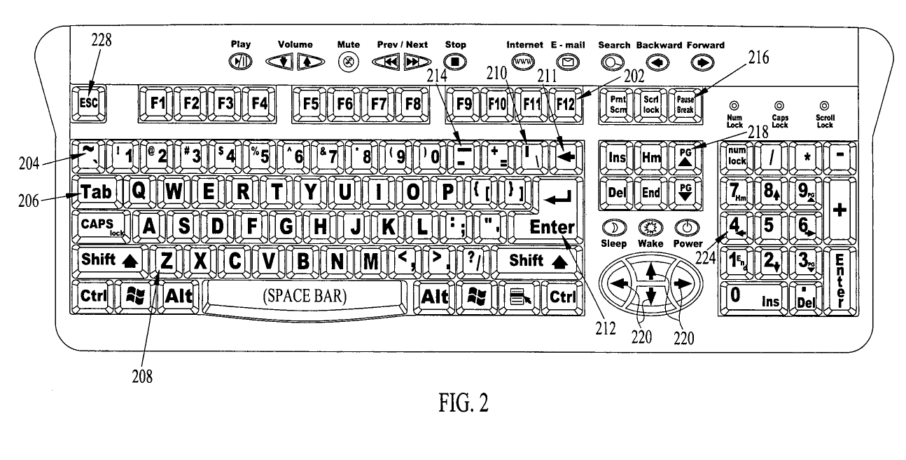

In one example, an enhanced visibility lettering system comprised of a standard QWERTY layout keyboard having unique larger letter, number and symbol characters on some keys that are larger is provided as shown in FIG. 1.

Referring now to FIG. 1 there is shown an enhanced visibility character identification system for entering information into an electronic device, comprising an information entry system having means to enter information into an electronic device, larger characters centrally placed on the means to enter information that identify the letters, numbers, symbols and functions that the means to identify information control, larger means to enter information upon which the characters are centrally placed, and wherein the surface area used on the means to enter identification by the larger characters is greater than the surface area used by the characters on the keys of a conventional keyboard that does not have the enhanced visibility character identification system.

A computer is one example of an electronic device. Other examples include but are not limited to personal information managers such as a Palm Pilot, television sets, radios, and telephone systems.

Referring now to FIG. 1A, there is shown one embodiment of an enhanced visibility lettering system for entering data or other information.

Referring now to FIGS. 1A and 1B, it is seen that a standard QWERTY layout keyboard 100 having a first row of function keys 101 containing twelve keys 102; a second row of keys 103 having fifteen keys 104; a tab/caps/shift key group 105 having twelve keys 106; a standard QWERTY alphabetical key group 107 having twenty six keys 108; an enter key group 109 having a :/ key 110, a backspace key 111, and an enter key 112; a punctuation key group 113 having six keys 114, a display function key group 115 having three keys 116, a screen function key group 117 having eight keys 118, a cursor control key group 119 having six keys 120, keyboard indicators 121 having three light emitting diodes 122, a numeric keypad group 123 having seventeen keys 124, and an escape key 128 is provided. A media key group 125, an Internet key group 126 having six keys, and a computer control group 127 are also provided. The keyboard 100 of the present invention is one means to enter information into an electronic device as recited in the claims. Other means include but are not limited to a screen or touch pad.

Referring now to FIG. 1A and 1B it is seen that each one of the twelve keys 102 of the first row of keys 101 has larger characters 202 identifying that key's function centrally oriented on each key 101. It is also seen that each one of the fifteen keys of the second row of keys 103 has larger characters 204 centrally oriented on each key 103. It is also seen that each one of the twelve keys 106 of the tab/caps/shift key group 105 has larger characters 206 centrally oriented on each key 106. It is also seen that each one of the twenty-six keys 108 of the standard QWERTY alphabetical key group 107 has larger characters 208 centrally oriented on each key 108. It is also seen that each one of the :/ key 110, backspace key 111, and enter key 112 key of enter key group 109 has larger characters 210, 211, and 212 centrally oriented on :/ key 110, backspace key 111, and enter key 112 respectively. It is also seen that each one of the six keys 114 of punctuation key group 113 has larger characters 214 centrally oriented on each key 114. It is also seen that each one of the three keys 116 of the display function key group 115 has larger characters 216 centrally oriented on each key 116. It is also seen that each one of the eight keys 118 of the screen function key group 117 has larger characters 218 centrally oriented on each key 118. It is also seen that each of the six keys 120 of cursor control key group 119 has larger characters 220 centrally oriented on each key. It is also seen that each of the seventeen keys 124 of numeric keypad group 123 has larger characters 224 centrally oriented on each key. It is also seen that escape key 128 has larger characters 228 centrally located on escape key 128. In another embodiment of the invention, the characters are inscribed in white on a black background.

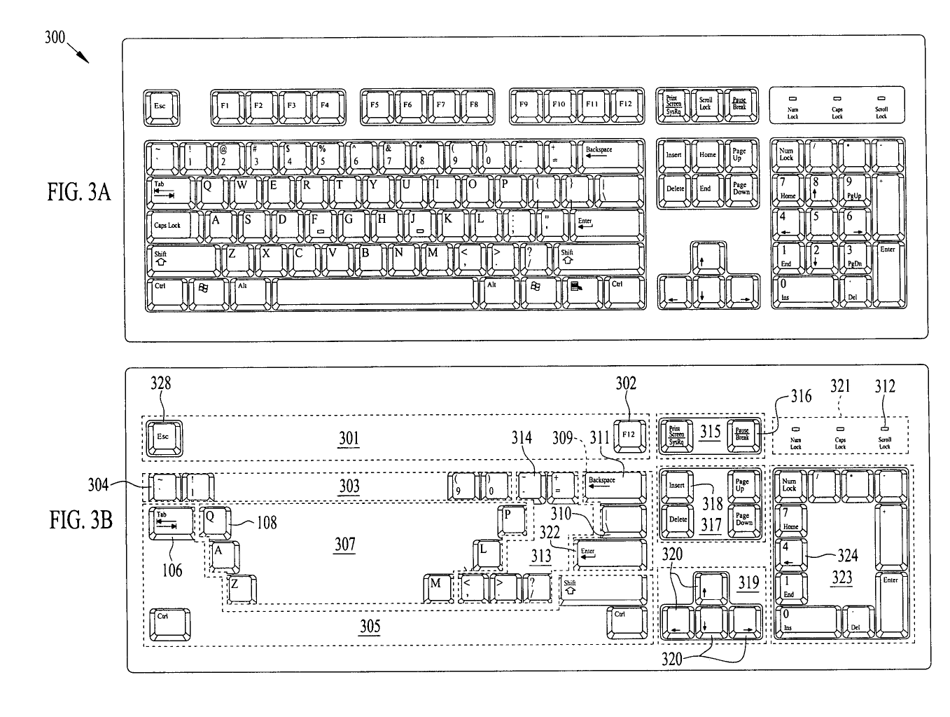

Referring now to FIG. 3 there is shown a standard QWERTY layout keyboard 300 that does not have the enhanced visibility character identification system of the present invention. It is seen that the keyboard 300 has a first row of function keys 301 containing twelve keys 302; a second row of keys 303 having fifteen keys 304; a tab/caps/shift key group 305 having twelve keys 306; a standard QWERTY alphabetical key group 307 having twenty six keys 308; an enter key group 309 having a :/ key 310, a backspace key 311, and an enter key 312; a punctuation key group 313 having six keys 314, a display function key group 315 having three keys 316, a screen function key group 317 having eight keys 318, a cursor control key group 319 having six keys 320, keyboard indicators 321 having three light emitting diodes 322, a numeric keypad group 323 having seventeen keys 324, and an escape key 328.

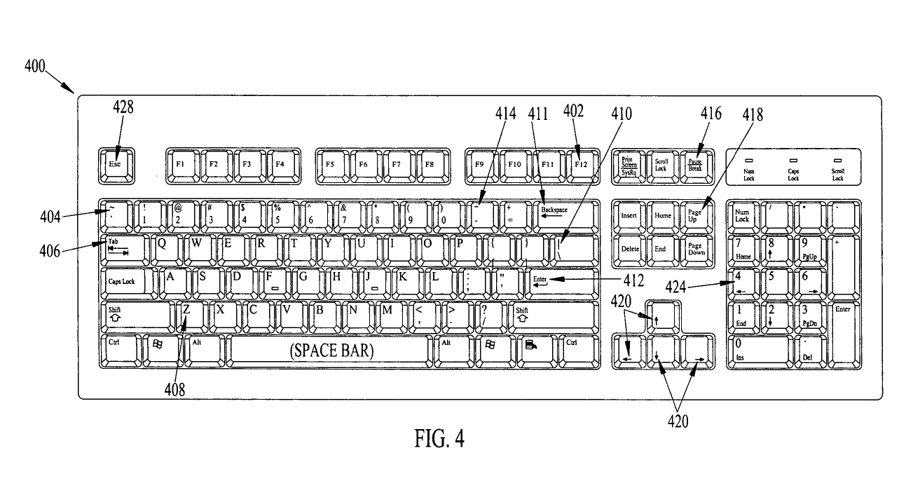

Referring now to FIGS. 3B and 4, it is seen that each one of the twelve keys 302 of the first row of keys 301 has characters 402 identifying that key's function placed on the middle left side of each key 301. It is also seen that each one of the fifteen keys of the second row of keys 303 has characters 404 placed on the left side of each key 303. It is also seen that each one of the twelve keys 306 of the tab/caps/shift key group 305 has characters 406 placed on the left side of each key 306. It is also seen that each one of the twenty-six keys 308 of the standard QWERTY alphabetical key group 307 has characters 408 placed on the upper left corner of each key 308. It is also seen that each one of the :/ key 310, backspace key 311, and enter key 312 key of enter key group 309 has characters 410, 411, and 412 placed on the left side of:/ key 310, backspace key 311, and enter key 312 respectively. It is also seen that each one of the six keys 314 of punctuation key group 313 has characters 414 placed on the left side of each key 314. It is also seen that each one of the three keys 316 of the display function key group 315 has characters 416 placed on the left middle side of each key 316. It is also seen that each one of the eight keys 318 of the screen function key group 317 has characters 418 placed on the middle left side of each key 318. It is also seen that each of the six keys 320 of cursor control key group 319 has characters 420 placed on a bottom corner of each key 320. It is also seen that each of the seventeen keys 324 of numeric keypad group 323 has characters 424 placed on the left side of each key 324. It is also seen that escape key 328 has characters 428 placed on the left middle side of escape key 128.

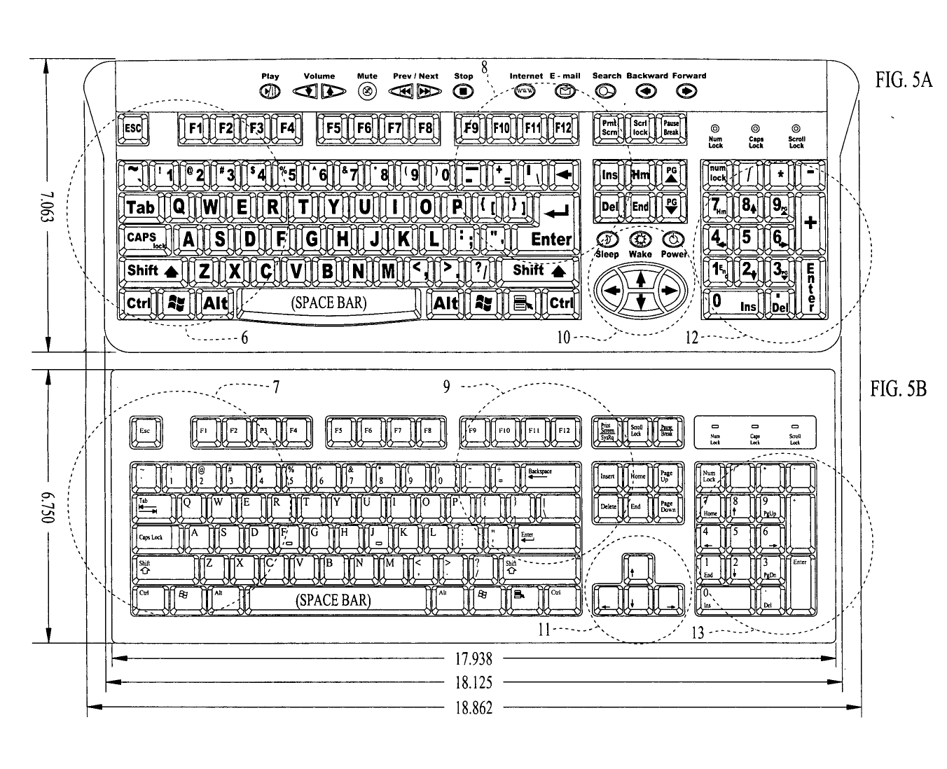

Referring now to FIG. 5A it is seen that a keyboard 100 that has the enhanced visibility character identification system is 7.063 inches wide and 18.862 inches long. Referring now to FIG. 5B it is seen that a conventional keyboard 300 that does not have the enhanced visibility character identification system is 6.750 inches wide and is 17.938 inches long. The footprint size of the enhanced character identification system keyboard 100 is similar to that of a conventional computer keyboard 300 that does not have the enhanced visibility character identification system.

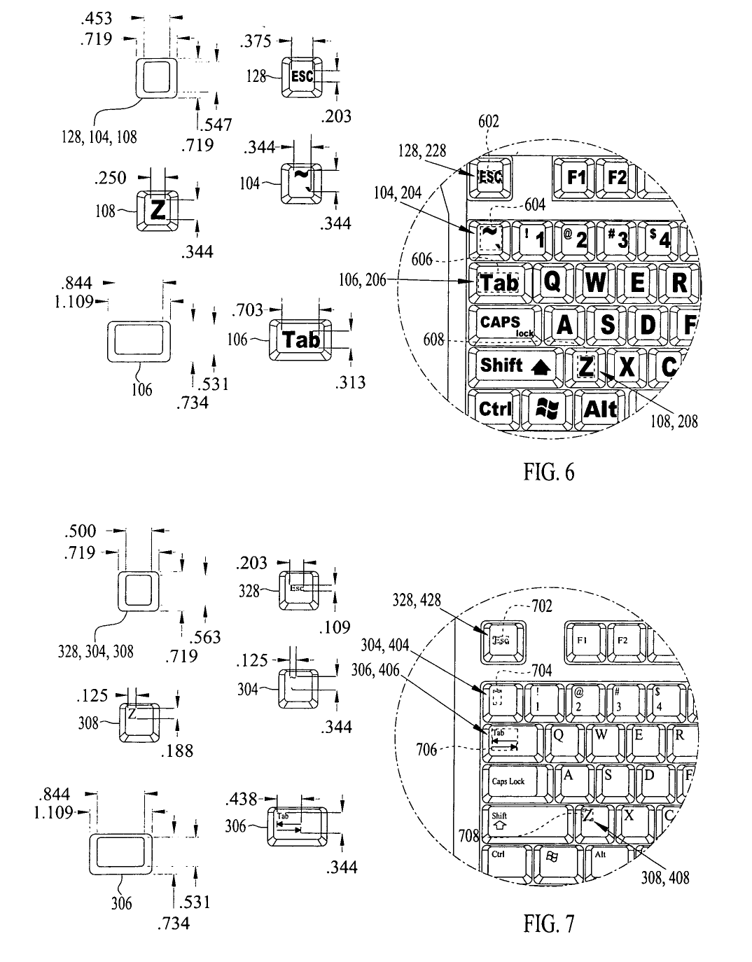

Referring now to FIGS. 6 and 7 it is seen that characters 202, 204, 206 and 208 of the present invention 100 occupy a larger surface area 602, 604, 606 and 608 of the keys 102, 104, 106 and 108 when compared with the surface area 702, 704, 706 and 708 used by the characters 402, 204, 206 and 208 on the keys 302, 304, 306 and 308 of a conventional keyboard 300 that does not have the enhanced character identification system. Specifically, it is seen that the surface area 602 covered by the characters 228 of escape key 128 is 0.076 square inches compared to the surface area 702 of 0.022 square inches covered by the characters 428 of escape key 328 of a conventional keyboard 300 that does not have the enhanced character visibility identification system. The surface area 604 covered by the characters 204 of keys 104 has a surface area of 0.118 square inches compared to the surface area 704 of 0.043 square inches covered by the characters 404 of keys 304 on a conventional keyboard 300 that does not have the enhanced character visibility identification system. The surface area 606 covered by the characters 206 of keys 106 is 0.220 square inches compared to the surface area 704 of 0.150 square inches covered by the characters 406 of keys 306 on a conventional keyboard 300 that does not have the enhanced character visibility identification system.

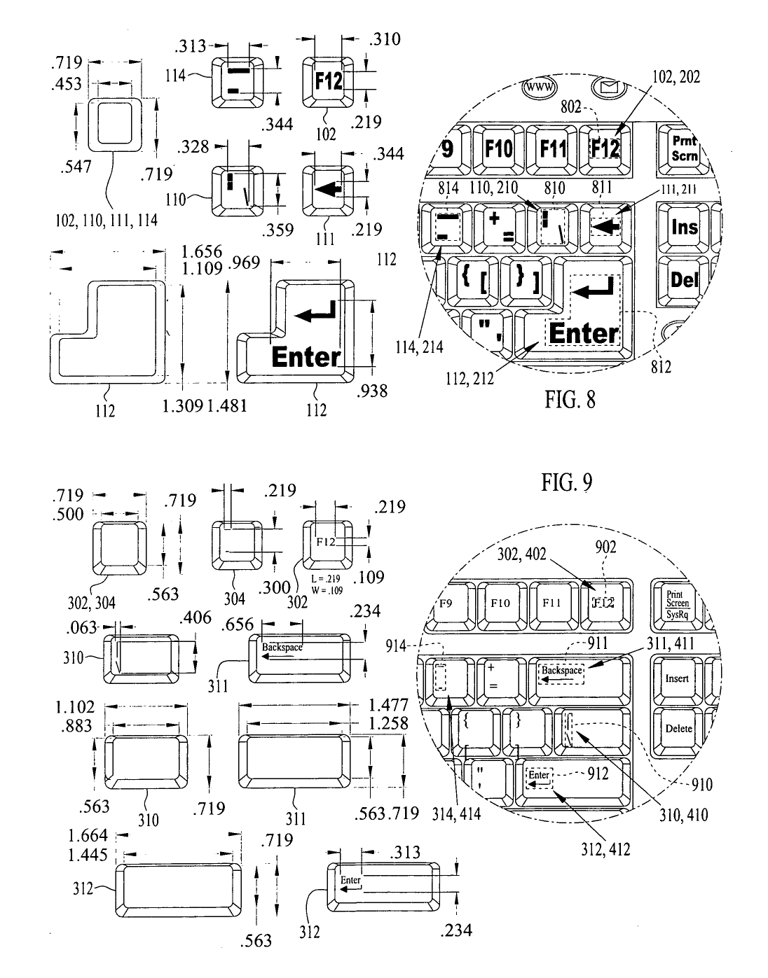

Referring now to FIGS. 8 and 9 it is seen that the enter key 112 of the present invention is larger than the enter key 312 of a conventional keyboard 300 that does not have the enhanced character identification system. It is also seen that characters 210, 211, 212 and 214 of the present invention 100 occupy a larger surface area 810, 811, 812 and 814 of the keys 110, 111, 112 and 114 when compared with the surface area 910, 911, 912 and 914 occupied by the characters 410, 411, 412 and 414 on the keys 310, 311, 312 and 314 of a conventional keyboard 300 that does not have the enhanced character identification system. Specifically, it is seen that the surface area 811 covered by the characters 211 of backspace key 111 is 0.075 square inches compared to the surface area 911 of 0.708 square inches covered by the characters 411 of backspace key 311 of a conventional keyboard 300 that does not have the enhanced character visibility identification system. It is also seen that the characters 211 occupy 30.3 percent of the total surface area of the backspace key 111 compared to 21.7 percent for the characters 411 of the backspace key 311 of a conventional keyboard 300 that does not have the enhanced character visibility identification system.

Referring to FIGS. 8 and 9 it is also seen that the surface area 810 covered by the characters 210 of :/ key 110 is 0.075 square inches compared to the surface area 911 of 0.708 square inches covered by the characters 411 of backspace key 311 of a conventional keyboard 300 that does not have the enhanced character visibility identification system. The surface area 814 covered by the characters 214 of long dash/short dash key 114 is 0.107 square inches compared to the surface area 911 of 0.065 square inches covered by the characters 414 of long dash/short dash key 314 of a conventional keyboard 300 that does not have the enhanced character visibility identification system. It is also seen that the surface area 812 covered by the characters 212 of the enter key 112 is 0.908 square inches compared to the surface area 912 of 0.073 square inches covered by the characters 412 on enter key 312 of a conventional keyboard 300 that does not have the enhanced character visibility identification system.

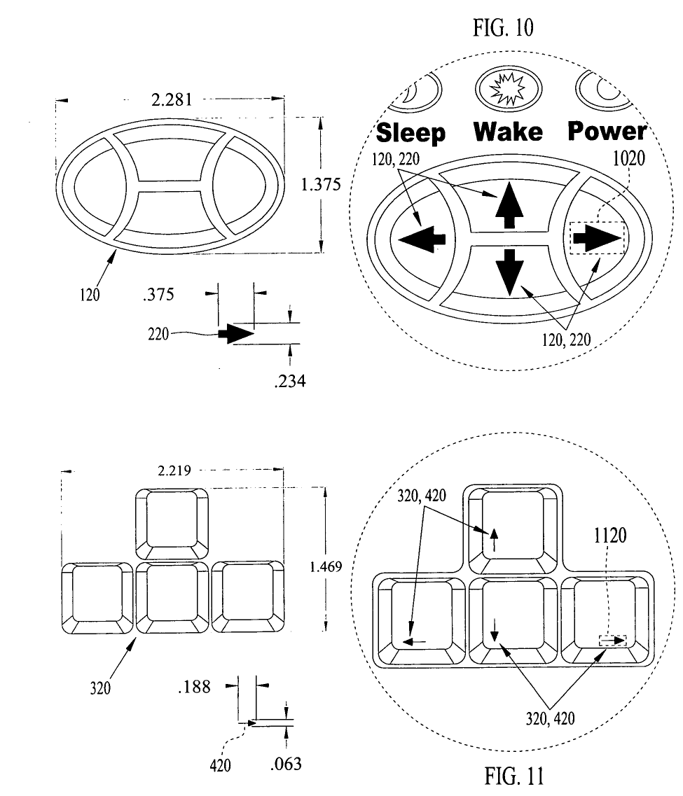

Referring now to FIGS. 10 and 11 it is seen that characters 220 of the present invention 100 cover a larger surface area 1020 of the cursor control keys 120 when compared with the surface area 1120 covered by the characters 420 on the cursor control keys 320 of a conventional keyboard 300 that does not have the enhanced character identification system. Specifically, it is seen that the surface area 1020 covered by the characters 220 of cursor control keys 120 is 0.087 square inches compared to the surface area 1120 of 0.011 square inches covered by the characters 420 of cursor control keys 320 of a conventional keyboard 300 that does not have the enhanced character visibility identification system. Specifically, it is seen that the surface area 1224 covered by the characters 224 of numeric control pad keys 120 is 0.087 square inches compared to the surface area 1120 of 0.011 square inches covered by the characters 420 of cursor control keys 320 of a conventional keyboard 300 that does not have the enhanced character visibility identification system.

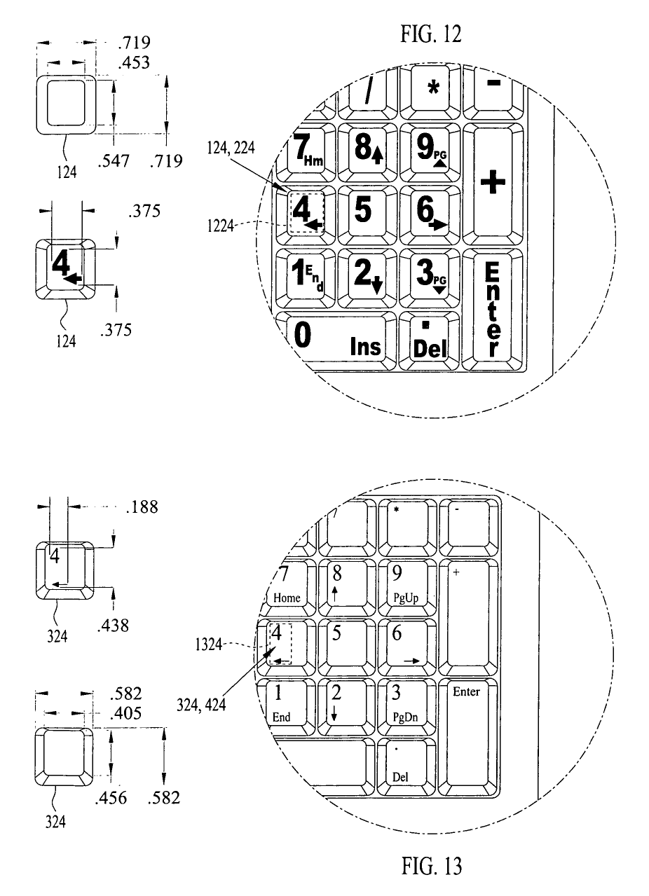

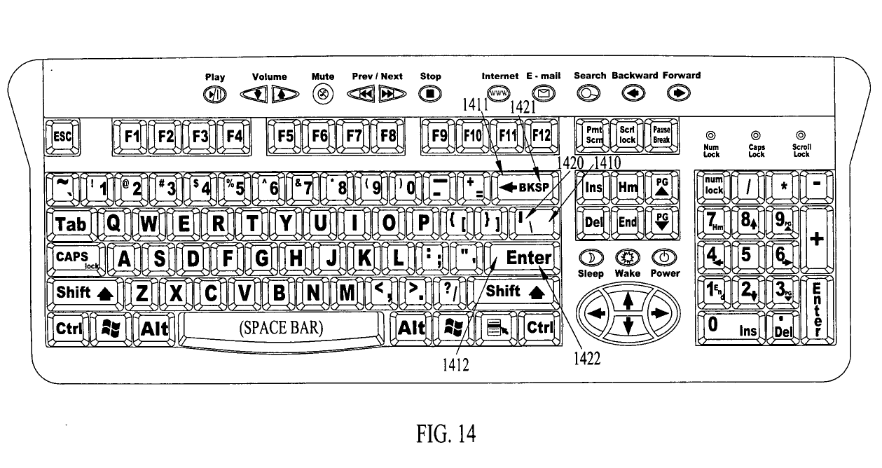

Referring now to FIGS. 12 and 13 it is seen that characters 224 of the present invention 100 occupy a larger surface area 1224 of the keys 124 when compared with the surface area 1320 occupied by the characters 424 on the keys 324 of a conventional keyboard 300 that does not have the enhanced character identification system.

Referring now to FIG. 14 there is shown a first preferred embodiment of the present invention, an internet ready keyboard comprising a standard QWERTY layout keyboard 1400 having a first row of function keys 101 containing twelve keys 102; a second row of keys 1403 having fourteen keys 1404; a tab/caps/shift key group 105 having twelve keys 106; a standard QWERTY alphabetical key group 107 having twenty six keys 108; an enter key group 1409 having a \ key 1410, a backspace key 1411, and an enter key 1412; a punctuation key group 113 having six keys 114, a display function key group 115 having three keys 116, a screen function key group 117 having eight keys 118, a cursor control key group 119 having six keys 120, keyboard indicators 121 having three light emitting diodes 122, a numeric keypad group 123 having seventeen keys 124, and an escape key 128, a media key group 125, an Internet key group 126 having an internet key 1430 that accesses the internet, an email key 1431 that activates an e-mail checking function, a search key 1432 that accesses a search engine, a backward key 1433 that moves the user back to the previous function, a forward key 1434 that moves the user forward, and a computer control group 127.

With the exception of the size of the backspace key 1411 and the size of the enter key 1412, the size of each of the keys on the internet ready keyboard 1400 are the same as the size of the keys on keyboard 100.

The internet ready keyboard 1400 is 7.063 inches wide and 18.862 inches long. The internet ready keyboard 1400 is the same width and length as the keyboard 100 as shown in FIG. 5A.

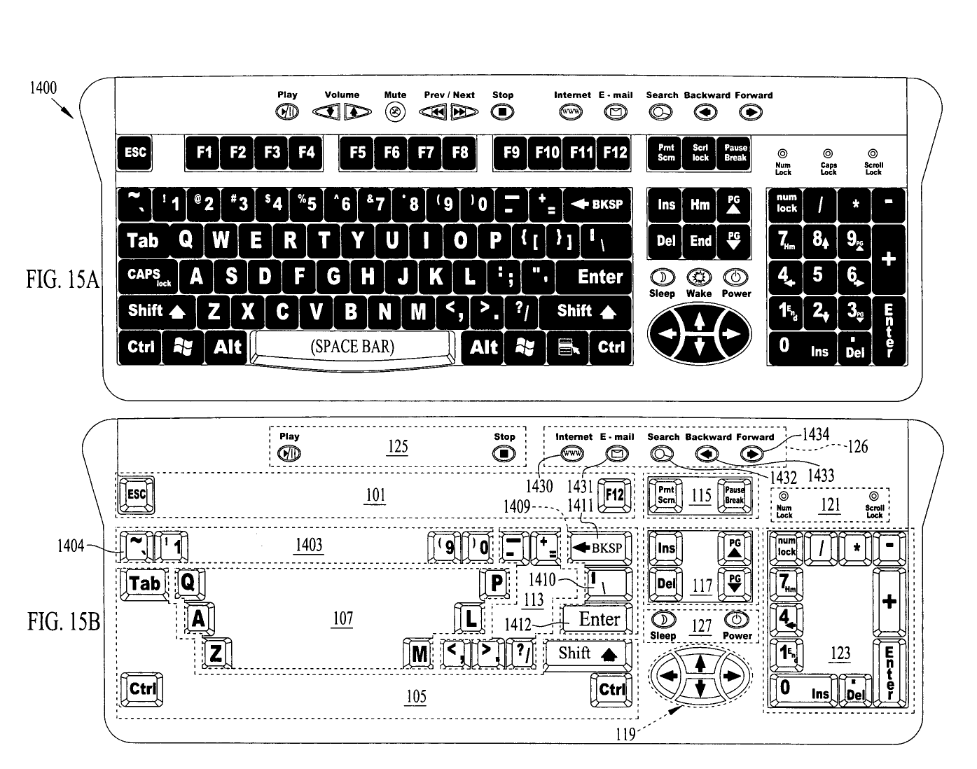

Referring now to FIGS. 15A and 15B it is seen that each one of the twelve keys 102 of the first row of keys 101 has larger characters 202 identifying that key's function centrally oriented on each key 101. It is also seen that each one of the fourteen keys of the second row of keys 1403 has larger characters 1404 identifying that key's function centrally oriented on each key 1403. It is also seen that each one of the twelve keys 106 of the tab/caps/shift key group 105 has larger characters 206 identifying that key's function centrally oriented on each key 106. It is also seen that each one of the twenty-six keys 108 of the standard QWERTY alphabetical key group 107 has larger characters 208 identifying that key's function centrally oriented on each key 108. It is also seen that each one of the \ key 1410, backspace key 1411, and enter key 1412 key of enter key group 1409 has larger characters 1420, 1421, and 1422 identifying that key's function centrally oriented on \key 1410, backspace key 1411, and enter key 1412 respectively. It is also seen that each one of the six keys 114 of punctuation key group 113 has larger characters 214 identifying that key's function centrally oriented on each key 114. It is also seen that each one of the three keys 116 of the display function key group 115 has larger characters 216 identifying that key's function centrally oriented on each key 116. It is also seen that each one of the eight keys 118 of the screen function key group 117 has larger characters 218 identifying that key's function centrally oriented on each key 118. It is also seen that each of the six keys 120 of cursor control key group 119 has larger characters 220 identifying that key's function centrally oriented on each key. It is also seen that each of the seventeen keys 124 of numeric keypad group 123 has larger characters 224 identifying that key's function centrally oriented on each key. It is also seen that escape key 128 has larger characters 228 identifying that key's function centrally located on escape key 128. In another embodiment of the invention, the characters are inscribed in white on a black background.

It is also seen that in this first preferred embodiment a larger backspace key 1411 with larger characters 1401 is provided, that the \ key 1410 is positioned above the enter key 1412 instead and that the enter key 1412 is the same size as the enter key 322 of a conventional keyboard that does not utilize the enhanced character identification system. The remaining keys and characters of the keyboard 1400 are the same size as those of the keyboard 100 and are placed in the same position that they occupy on keyboard 100.

The characters 202, 204, 206, 208, 210, 211, 212, 214, 216, 218, 220, 224, 1420, 1421, and 1422 for identifying letters numbers and symbols of the internet ready keyboard 1400 are larger than the characters 402, 404, 406, 408, 410, 411, 412, 414, 416, 418, 420 424 of a keyboard 300 that does not utilize the enhanced visibility character identification system.

As shown in FIGS. 6, 7, 10, 11, 12 and 13, the characters 228 on the escape key 128 are 0.375 inches across and 0.203 inches tall compared to 0.203 inches across and 0.109 inches tall for the characters 428 on the escape key 328 of a conventional keyboard 300 that does not have the enhanced visibility character identification system. The characters 202 on the keys 102 of the function key group 101 are 0.31 inches across and 0.219 inches tall compared to 0.219 inches across and 0.109 inches tall for the characters 402 on the keys 302 of the function key group 301 of a conventional keyboard 300 that does not have the enhanced visibility character identification system. The characters 204 on the keys 104 in the first row of keys 103 are 0.344 inches across and 0.344 inches tall compared to 0.125 inches across and 0.344 inches tall for the characters 404 on the keys 304 of the first row of keys 303 of a conventional keyboard 300 that does not have the enhanced visibility character identification system. For example, the characters 206 on the keys 106 of the tab/caps/alt/shift key group 105 are 0.703 inches across and 0.313 inches tall compared to 0.438 inches across and 0.344 inches tall for the characters 406 on the keys 306 of the tab/caps/alt/shift key group 305 of a conventional keyboard 300 that does not have the enhanced visibility character identification system. The characters 208 on the keys 108 of the alphabetical key group 107 are 0.25 inches across and 0.344 inches tall compared to 0.125 inches across and 0.188 inches tall for the characters 408 on the keys 308 of the alphabetical key group 307 of a conventional keyboard 300 that does not have the enhanced visibility character identification system.

The characters 214 on the long dash/short dash key 114 are 0.313 inches across and 0.344 inches tall compared to 0.219 inches across and 0.300 inches tall for the characters 414 on the long dash/short dash key 314 of a conventional keyboard 300 that does not have the enhanced visibility character identification system.

The characters 220 on the keys 120 of the cursor control key group 120 are 0.375 inches across and 0.234 inches tall compared to 0.188 inches across and 0.0625 inches tall for the characters 420 on the keys 320 of the cursor control key group 319 of a conventional keyboard 300 that does not have the enhanced visibility character identification system.

The characters 202, 204, 206, 208, 1409, 1420, 1422, 216, 218, 220, and 224 utilize a larger portion of the surface area of the keys 102, 104, 106, 108, 1410, 1412, 1420, 112, 114, 116, 118, 120, and 124 of internet ready keyboard 1400 than do the characters 402, 404, 406, 408, 410, 411, 412, 414, 416, 418, 420 and 424 of a conventional keyboard 300 that does not have the enhanced character identification system.

Because the characters of the enhanced visibility lettering system and its embodiments more efficiently use the total surface area of the keys inscribed with the characters of the enhanced visibility character identification system, the enhanced visibility character identification system can be implemented on a keyboard 100 and 1400 whose overall footprint size is the similar to the footprint size of a conventional computer keyboard 300 that does not have the enhanced visibility character identification system.

The internet ready keyboard 1400 may be used by visually impaired and other persons to facilitate use of an electronic or other device. Because the internet ready keyboard 1400 provides a unique combination of larger characters centrally oriented on its keys, computer users may find it easier to recognize the characters and keys of the internet ready keyboard 1400.

Visually impaired users will find the internet ready keyboard 1400 particularly suitable to their needs because the Snellen rating of the internet ready keyboard 1400 is 20/300 compared with a Snellen rating of 20/70 for typical computer keyboards 300. In other words, a user of a typical computer keyboard 300 must have vision of 20/70 or better to use a that typical computer keyboard 300. The internet ready keyboard 1400 can be used by a user whose vision is 20/300 or better. It is to be noted that users with vision of less than 20/200 are considered to be legally blind.

Workers, home users, hobbyists, and other users may find the internet ready keyboard 1400 more amenable and more accurate to use because the larger characters depicting letters, numbers and symbols are easier to identify in a variety of light levels including but not limited to normal light, low light, night time or special nighttime lighting such as red light.

It is to be understood that the examples shown above are for illustrative purposes only, and that the particular materials and construction as well as other details are not to be construed in a manner that would limit the scope of the present invention.

1. An enhanced visibility character identification system, comprising:
means to enter information into an electronic device;
larger characters identifying the letters, numbers, symbols and functions that the means to enter information control;
the means to enter information upon which the characters are placed are larger than the keys of a conventional keyboard;
wherein the larger characters are centrally oriented on the means for entering information; and
wherein the surface area used by the larger characters is greater than the surface area used by the characters on the keys of a keyboard that does not have the enhanced visibility lettering system.

2. The enhanced visibility character identification system of claim 1, wherein the means to enter information are the keys of a QWERTY layout keyboard.

3. The enhanced visibility character identification system of claim 1, wherein the means to enter information is a screen.

4. The enhanced visibility character identification system of claim 1, wherein the means to enter identification is a touchpad.

5. The enhanced visibility character identification system of claim 2, wherein the characters are inscribed in white on a black background.

6. An enhanced visibility character identification system, comprising a standard QWERTY layout keyboard having a first row of function keys containing twelve keys; a second row of keys having fifteen keys; a tab/caps/shift key group having twelve keys; a standard QWERTY alphabetical key group having twenty six keys; an enter key group having a :/ key, a backspace key, and an enter key; a punctuation key group having six keys, a display function key group having three keys, a screen function key group having eight keys, a cursor control key group having six keys, keyboard indicators having three light emitting diodes, a numeric keypad group having seventeen keys, an escape key; a media key group, an Internet key group, and a computer control key group;
larger characters identifying the letters, numbers, symbols and functions that the keys control;
wherein the larger characters are centrally oriented on the keys, and
wherein the surface area used by the larger characters is greater than the surface area used by the characters on the keys of a keyboard that does not have the enhanced visibility lettering system.

7. The enhanced visibility character identification system of claim 6, wherein the characters are inscribed in white on a black background.

8. The enhanced visibility character identification system of claim 6, wherein the characters are inscribed in white on a charcoal grey background.

9. The enhanced visibility character identification system of claim 6, wherein the characters are inscribed in black on a white background.

10. The enhanced visibility character identification system of claim 6, wherein the characters are inscribed in black on an off white background

11. An internet ready keyboard, comprising a standard QWERTY layout keyboard having a first row of function keys containing twelve keys; a second row of keys having fifteen keys; a tab/caps/shift key group having twelve keys; a standard QWERTY alphabetical key group having twenty six keys; an enter key group having a :/ key, a backspace key, and an enter key; a punctuation key group having six keys, a display function key group having three keys, a screen function key group having eight keys, a cursor control key group having six keys, keyboard indicators having three light emitting diodes, a numeric keypad group having seventeen keys, an escape key; a media key group; an Internet key group having an internet key, an email key, a search key, a backward function key, and a forward function key, a computer control key group;
larger characters identify the letters, numbers, symbols and functions that the keys control;
wherein the larger characters are centrally oriented on the keys, and
wherein the surface area used by the larger characters is greater than the surface area used by the characters on the keys of a conventional keyboard.

12. The internet ready keyboard of claim 11, wherein the characters are inscribed in white on a black background.

13. The internet ready keyboard of claim 11, wherein the characters are inscribed in white on a black background.

14. The internet ready keyboard of claim 11, wherein the characters are inscribed in white on a charcoal grey background.

15. The internet ready keyboard of claim 11, wherein the characters are inscribed in black on a white background.

16. The internet ready keyboard of claim 11, wherein the characters are inscribed in black on an off white background.
